(19) United States
(12) Patent Application Publication
(10) Pub. No.: US 2023/0334349 A1
(43) Pub. Date: Oct. 19, 2023

(54) SYSTEM AND METHOD FOR RANDOM TAXONOMICAL MUTATION

(71) Applicant: Million Doors, Inc., San Francisco, CA (US)

(72) Inventors: Craig M. TRIM, Ventura, CA (US); John Jien KAO, San Francisco, CA (US)

(21) Appl. No.: 18/301,401

(22) Filed: Apr. 17, 2023

Related U.S. Application Data
(63) Continuation of application No. PCT/US2023/018587, filed on Apr. 14, 2023.
(60) Provisional application No. 63/332,183, filed on Apr. 18, 2022.

(51) Int. Cl. G06N 5/045; G06N 5/022

(52) U.S. Cl. CPC G06N 5/045; G06N 5/022

(57) ABSTRACT

Described herein are platforms, systems, media, and methods for assessing the resiliency of reasoning of an expert system comprising a natural language interface and a graph database.

### CROSS-REFERENCE TO RELATED APPLICATIONS

This application is a continuation of PCT Application No. PCT/US2023/018587, filed Apr. 14, 2023, which claims the benefit of U.S. Provisional Application No. 63/332,183, filed Apr. 18, 2022, each of which is incorporated herein by reference in its entirety.

### BACKGROUND

Expert systems and chatbots have proliferated rapidly and are in use in many industries. Many expert systems and chatbots use artificial intelligence (AI) to emulate the decision-making ability of a human.

### SUMMARY

A expert system that supports a natural language interface is very challenging. Language is both infinite and ambiguous. No expert system with a natural language front-end will ever be perfect. In addition, performance measurement is a challenge. Researchers and developers can take metrics on a production instance, but it is particularly challenging and elusive to predict and identify poorly performing areas in advance.

Graphs are a useful aid in reasoning for an expert system. They are, however, susceptible to erroneous information. The risk from “fake news” or misinformation is as impactful to an ontology-driven natural language processing (NLP) solution as a statistically trained model. However, the impact is different for both. For a statistically trained model, developers may have initially trained the model with, for example, 10 million rows of text. Among those rows may come data that is factually inaccurate. The output will vary statistically due to the size of the erroneous input.

An ontology is more precise and can learn nuances more quickly. For example, rather than adding, for example, 1 million rows of training data to train on and differentiate a concept from existing concepts accurately, an ontology requires the correct placement of ideas (or a sub-graph) within the existing graph space. This rapid nature of an ontology to benefit from editing makes it a candidate for enabling an advanced expert system. However, it does mean that the ontology is prone to more rapid shifts in judgment. For example, acquiring a less trustworthy data source can quickly shift the conclusion of a system in a particular direction.

For an expert system to establish and maintain trust, it must display the reasoning behind the answer. Many expert systems do not deal in domains with a single correct answer. For any sufficiently complex expert system, there is often no correct answer. By way of non-limiting example, an expert system in a scientific domain such as the oil and gas industry primarily deals with unknown quantities and hypothesized information. In this example, the reasoning is not only the evidence for the reply; it is the primary acceptance criteria. Unfortunately, evidence can run very deep in a system, and there is often no simple way to display all of it at once for a user to consume.

By way of example, in current systems, if the user queries, “Who was the Queen of blighty in 1967?” The system needs to respond appropriately and does this by determining the intent of the user query and using that to find the correct activity within a business process to initiate the dialog. The intent is found by first pre-processing the sentence (replacing synonyms such as “blighty” with “England”) and then annotating the sentence with concepts found in the graph. In this example, that would be Queen and England. The system then uses these concepts as a constrained set of pointers into the graph space and finds possible solutions.

Described herein is Random Taxonomical Mutation (RTM). In some embodiments, RTM is a system and method that assesses the resiliency of reasoning within a graph. In further embodiments, RTM outcome is a score that determines how likely the system is to “change its mind” when encountering new data. This metric becomes a measure of resilience for reasoning in a graph and, in some embodiments, RTM is technique that consolidates an interpretation of the reasoning into a single score.

In some embodiments, RTM determines the frequency of accurate reasoning over a complex question in graph space. Iterative usage with random sampling allows RTM to develop a standard deviation from a known norm. The deviation metric indicates how likely the system is to succeed or fail for a particular query and provides a measure of resilience for reasoning in a graph.

In some embodiments, RTM is a technique that may either add or subtract semantic relationships from the graph. In such embodiments, this activity results in a graph mutation and is randomized within a set of controlled parameters. The outcome of this activity is a new graph the system will use to answer the same question. When reasoning over the new graph, the system may or may not return a different answer to the question.

If each random change results in a completely different line of reasoning for the same question, we would consider that the question has, by way of example, “high jitter.” Jitter is, in this example, non-technical jargon that describes frequent deviation from the norm in either direction from the mean. If each mutation has minimal impact on the line of reasoning for the same question, we would consider that the question has, by way of example, “low jitter.” In this example, low jitter implies the system reasoning is highly resilient for this particular line of questioning.

So-called “jitter” matters for reasoning. It is useful for a given query (or generalized intent) to know how resilient the system can reason in that space. Queries that manifest high jitter are likely to be more susceptible to new data sources and unseen assertions. To put this into specific terms, if we build an expert system and the customer identifies an essential set of user queries the system must answer, we want to predict performance. If the expert system ingests a rapidly changing domain of source data (such as news bulletins or journal publications), acquiring a new document or data source that contains information as yet unseen will happen throughout the system lifecycle. This event can impact the system's reasoning. It can be very problematic to develop an expert system that gives a different answer to the same question daily. Such a system is considered non-deterministic and, outside of research interest, rarely maintains user trust.

For learning to maintain user trust, the system must manifest a linear progression in confidence. By way of example, an image recognition system may differentiate images of 3s from Bs with low confidence but, over time, would be expected to gain confidence in this ability. However, a system that describes a “3” as a “7” one day and an “X” the next day is not going to gain trust. This example is simplified. Image recognition is a Boolean truth function. The system either classifies the image correctly, or it doesn't. For complex text queries, the answer may involve, by way of further example, which eight articles to position from a corpus of several million. A system that manifests high jitter during the RTM process will consistently select a different set of documents. A system with low jitter in the RTM process will choose from a smaller subset of results, and the variation in selection may be more explainable.

In some embodiments, RTM outcome is a set of questions (or intents) with an associated predictive value. In such embodiments, the predictive value forecasts how likely the system deviates from an expected reasoning pattern ingesting unforeseen data. The utility of RTM measurements extends in, by way of non-limiting examples, development, maintenance, and trust-building for expert systems. Each result should pair with the confidence behind the reasoning and how resilient that reasoning is to further assertions.

Returning to the previous example, if the user asks, “Who was the Queen of blighty in 1967?” the system responds:
Answer=Queen Elizabeth
Confidence=87%
RTM=10%

As such, in this example, the user sees that the system was highly confident in the outcome and that new data and assertions will be unlikely to change the outcome. This score is a critical and missing component in existing expert systems.

Accordingly, in one aspect, disclosed herein are computer-implemented systems for assessing the resiliency of reasoning of an expert system comprising a natural language interface and a graph database, the system comprising at least one computing device comprising at least one processor and instructions executable by the at least one processor to perform assessment operations comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; and generating a predictive output comprising a measure of potential future mutability of outcome when the expert system ingests new data or a measure of potential deviation from an expected reasoning pattern when the expert system ingests new data. In some embodiments, the test input comprises underspecified queries, fully specified, and overspecified queries. In some embodiments, the clustering algorithm comprises a k-Nearest Neighbor (kNN) algorithm. In some embodiments, the assessment operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In other embodiments, modifying the clusters comprises subtracting at least one semantic relationship from the graph. In further embodiments, the mutation parameter constrains the randomized mutation to modifying about 1%, about 2%, about 3%, about 4%, about 5%, about 6%, about 7%, about 8%, about 9%, or about 10% of the edges of the graph. In further embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In further embodiments, the mutation parameter constrains the randomized mutation modifying about than 1% to about 5% of the edges of the graph. In further embodiments, the mutation parameter constrains the randomized mutation to modifying about than 5% to about 10% of the edges of the graph. In some embodiments, the mutation does not comprise modifying a node of the graph. In some embodiments, the assessment operations further comprise updating the mutation parameter in response to the new responses of the expert system to the test input. In some embodiments, the baseline responses and the new responses of the expert system comprise an answer to each query and a confidence level for the answer to each query. In some embodiments, the assessment operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is provided as a measure of jitter.

In another aspect, disclosed herein are computer-implemented systems comprising: an expert system comprising a natural language interface and a graph database; and at least one computing device comprising at least one processor and instructions executable by the at least one processor to perform operations for assessing the resiliency of reasoning of the expert system, the operations comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; generating a predictive output comprising a measure of potential future mutability of outcome when the expert system ingests new data or a measure of potential deviation from an expected reasoning pattern when the expert system ingests new data; and providing the predictive output to the expert system or a user of the expert system. In some embodiments, the test input comprises underspecified queries, fully specified, and overspecified queries. In some embodiments, the clustering algorithm comprises a k-Nearest Neighbor (kNN) algorithm. In some embodiments, the assessment operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In other embodiments, modifying the clusters comprises subtracting at least one semantic relationship from the graph. In various embodiments, the mutation parameter constrains the randomized mutation to modifying about 1%, about 2%, about 3%, about 4%, about 5%, about 6%, about 7%, about 8%, about 9%, or about 10% of the edges of the graph. In various embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In some embodiments, the mutation parameter constrains the randomized mutation modifying about than 1% to about 5% of the edges of the graph. In some embodiments, the mutation parameter constrains the randomized mutation to modifying about than 5% to about 10% of the edges of the graph. In some embodiments, the mutation does not comprise modifying a node of the graph. In some embodiments, the assessment operations further comprise updating the mutation parameter in response to the new responses of the expert system to the test input. In some embodiments, the baseline responses and the new responses of the expert system comprise an answer to each query and a confidence level for the answer to each query. In some embodiments, the assessment operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is expressed as a measure of jitter.

In another aspect, disclosed herein are computer-implemented methods of assessing the resiliency of reasoning of an expert system comprising a natural language interface and a graph database, the method comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; and generating a predictive output comprising a measure of potential future mutability of outcome when the expert system ingests new data or a measure of potential deviation from an expected reasoning pattern when the expert system ingests new data. In some embodiments, the test input comprises underspecified queries, fully specified, and overspecified queries. In some embodiments, the clustering algorithm comprises a k-Nearest Neighbor (kNN) algorithm. In some embodiments, the mutation operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In other embodiments, modifying the clusters comprises subtracting at least one semantic relationship from the graph. In various embodiments, the mutation parameter constrains the randomized mutation to modifying about 1%, about 2%, about 3%, about 4%, about 5%, about 6%, about 7%, about 8%, about 9%, or about 10% of the edges of the graph. In various embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In some embodiments, the mutation parameter constrains the randomized mutation modifying about than 1% to about 5% of the edges of the graph. In some embodiments, the mutation parameter constrains the randomized mutation to modifying about than 5% to about 10% of the edges of the graph. In some embodiments, the mutation does not comprise modifying a node of the graph. In some embodiments, the mutation operations further comprise updating the mutation parameter in response to the new responses of the expert system to the test input. In some embodiments, the baseline responses and the new responses of the expert system comprise an answer to each query and a confidence level for the answer to each query. In some embodiments, the mutation operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is expressed as a measure of jitter.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a computing device; in this case, a device with one or more processors, memory, storage, and a network interface;

FIG. 2 shows a non-limiting example of a conceptual diagram; in this case, a diagram illustrating a conceptualization of the clustering algorithm described herein;

FIG. 3 shows a non-limiting example of an approach in regression analysis; in this case, the least squares method;

FIG. 4 shows a non-limiting example of a conceptual diagram; in this case, a diagram illustrating a conceptualization of a node considered part of two clusters simultaneously based on two types of relationships;

FIG. 5 shows a non-limiting example of a conceptual diagram; in this case, a diagram illustrating a conceptualization of a cluster with a largely homogenous set of entities with mutations to the relationships therebetween;

FIG. 6 shows a non-limiting example of a contingency computation described herein; and

FIG. 7 shows a non-limiting example of an architecture and process diagram; in this case, an architecture and process diagram illustrating the iterative nature of the subject matter described herein.

### DETAILED DESCRIPTION

The advantages and value of the subject matter described herein is manifest. RTM, in some embodiments, helps build user trust in an expert system. Without explanations behind an expert system's internal functionalities and its decisions, there is a risk that the model would not be considered trustworthy or legitimate. A model which can explain its predictions can go a long way in building trust. Expert system users increasingly indicate their desire to interact with the system reasoning potential rather than just the answers (the output). Evidence, in some cases, is more important to users, particularly in scientific domains. In some cases, there are legal implications when financial outcomes for example are at stake, including the ability to grant a loan. Moreover, expert systems must remain flexible enough to be continually maintained and improved as ethical issues are discovered and addressed. The administration of transparent and explainable AI systems is, therefore desirable.

Described herein, in certain embodiments, are computer-implemented systems for assessing the resiliency of reasoning of an expert system comprising a natural language interface and a graph database, the system comprising at least one computing device comprising at least one processor and instructions executable by the at least one processor to perform assessment operations comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; and generating a predictive output comprising a measure of potential future mutability of outcome when the expert system ingests new data or a measure of potential deviation from an expected reasoning pattern when the expert system ingests new data. In some embodiments, the test input comprises underspecified queries, fully specified, and overspecified queries. In some embodiments, the clustering algorithm comprises a k-Nearest Neighbor (kNN) algorithm. In some embodiments, the assessment operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In still further embodiments, modifying the clusters comprises subtracting at least one semantic relationship from the graph. In further embodiments, the mutation parameter constrains the randomized mutation to modifying about 1%, about 2%, about 3%, about 4%, about 5%, about 6%, about 7%, about 8%, about 9%, or about 10% of the edges of the graph. In further embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In further embodiments, the mutation parameter constrains the randomized mutation modifying about than 1% to about 5% of the edges of the graph. In further embodiments, the mutation parameter constrains the randomized mutation to modifying about than 5% to about 10% of the edges of the graph. In some embodiments, the mutation does not comprise modifying a node of the graph. In some embodiments, the assessment operations further comprise updating the mutation parameter in response to the new responses of the expert system to the test input. In some embodiments, the baseline responses and the new responses of the expert system comprise an answer to each query and a confidence level for the answer to each query. In some embodiments, the assessment operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is provided as a measure of jitter.

Also described herein, in certain embodiments, are computer-implemented systems comprising: an expert system comprising a natural language interface and a graph database; and at least one computing device comprising at least one processor and instructions executable by the at least one processor to perform operations for assessing the resiliency of reasoning of the expert system, the operations comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; generating a predictive output comprising a measure of potential future mutability of outcome when the expert system ingests new data or a measure of potential deviation from an expected reasoning pattern when the expert system ingests new data; and providing the predictive output to the expert system or a user of the expert system. In some embodiments, the test input comprises underspecified queries, fully specified, and overspecified queries. In some embodiments, the clustering algorithm comprises a k-Nearest Neighbor (kNN) algorithm. In some embodiments, the assessment operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In other embodiments, modifying the clusters comprises subtracting at least one semantic relationship from the graph. In various embodiments, the mutation parameter constrains the randomized mutation to modifying about 1%, about 2%, about 3%, about 4%, about 5%, about 6%, about 7%, about 8%, about 9%, or about 10% of the edges of the graph. In various embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In some embodiments, the mutation parameter constrains the randomized mutation modifying about than 1% to about 5% of the edges of the graph. In some embodiments, the mutation parameter constrains the randomized mutation to modifying about than 5% to about 10% of the edges of the graph. In some embodiments, the mutation does not comprise modifying a node of the graph. In some embodiments, the assessment operations further comprise updating the mutation parameter in response to the new responses of the expert system to the test input. In some embodiments, the baseline responses and the new responses of the expert system comprise an answer to each query and a confidence level for the answer to each query. In some embodiments, the assessment operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is expressed as a measure of jitter.

Also described herein, in certain embodiments, are computer-implemented methods of assessing the resiliency of reasoning of an expert system comprising a natural language interface and a graph database, the method comprising: recording a baseline graph of the expert system; submitting a test input to the expert system, the expert system utilizing the baseline graph, the test input comprising a plurality of queries; recording baseline responses of the expert system to the test input; applying an algorithm to iteratively perform randomized mutation of the graph, constrained according to a mutation parameter, by performing mutation operations comprising: executing an unsupervised clustering algorithm across the graph, modifying each cluster, reassembling the modified clusters into a modified graph, persisting the modified graph of the expert system, submitting the test input to the expert system, the expert system utilizing the modified graph, and recording new responses of the expert system to the test input; and generating a predictive output comprising a measure of potential future mutability of outcome when the expert system ingests new data or a measure of potential deviation from an expected reasoning pattern when the expert system ingests new data. In some embodiments, the test input comprises underspecified queries, fully specified, and overspecified queries. In some embodiments, the clustering algorithm comprises a k-Nearest Neighbor (kNN) algorithm. In some embodiments, the mutation operations further comprise setting the mutation parameter. In some embodiments, modifying the clusters comprises modifying one or more edges of the graph. In further embodiments, modifying one or more edges of the graph comprises: adding at least one semantic relationship to the graph, subtracting at least one semantic relationship from the graph, or both. In still further embodiments, modifying the clusters comprises adding at least one semantic relationship to the graph. In other embodiments, modifying the clusters comprises subtracting at least one semantic relationship from the graph. In various embodiments, the mutation parameter constrains the randomized mutation to modifying about 1%, about 2%, about 3%, about 4%, about 5%, about 6%, about 7%, about 8%, about 9%, or about 10% of the edges of the graph. In various embodiments, the mutation parameter constrains the randomized mutation to modifying less than 1%, less than 2%, less than 3%, less than 4%, less than 5%, less than 6%, less than 7%, less than 8%, less than 9%, or less than 10% of the edges of the graph. In some embodiments, the mutation parameter constrains the randomized mutation modifying about than 1% to about 5% of the edges of the graph. In some embodiments, the mutation parameter constrains the randomized mutation to modifying about than 5% to about 10% of the edges of the graph. In some embodiments, the mutation does not comprise modifying a node of the graph. In some embodiments, the mutation operations further comprise updating the mutation parameter in response to the new responses of the expert system to the test input. In some embodiments, the baseline responses and the new responses of the expert system comprise an answer to each query and a confidence level for the answer to each query. In some embodiments, the mutation operations further comprise quantifying deviations in both confidence levels and responses between the baseline responses and the new responses. In some embodiments, the predictive output comprises a measure of how resilient to further assertions the reasoning of the expert system is with respect to a query. In some embodiments, the predictive output is provided to the expert system or a user of the expert system. In some embodiments, the predictive output is expressed as a measure of jitter.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

As used herein, “expert system” means any system that can accept a natural language query and provide a response, including by way of non-limiting examples, decision support systems and chatbots.

### Computing System

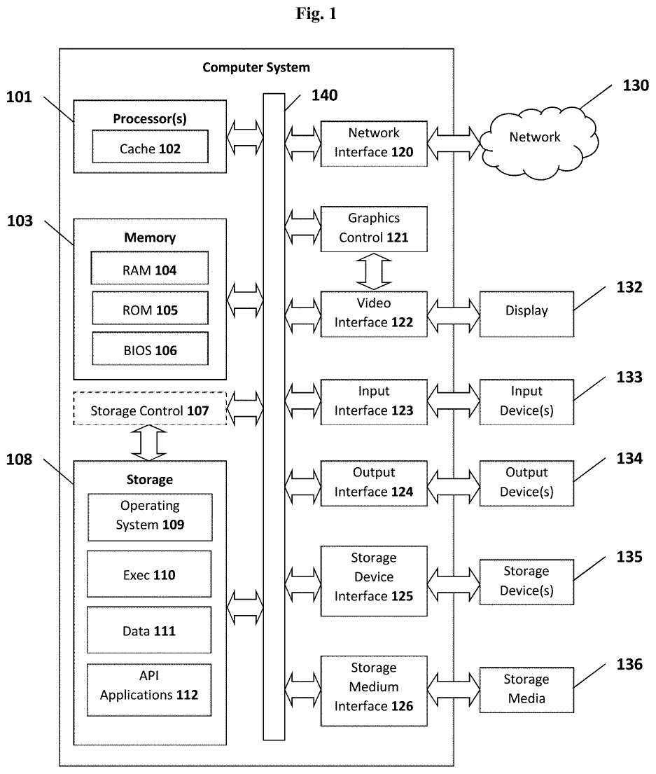

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, expert system, query, test input, mutation parameter, graph, predictive output, potential future mutability of outcome, and jitter scoring information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Exemplary Methodology

This disclosure proposes a method and system that randomly mutates a graph. Mutations may involve removing semantic relationships or adding new semantic relationships. Modifications are performed in a randomized fashion using a controlled set of parameters.

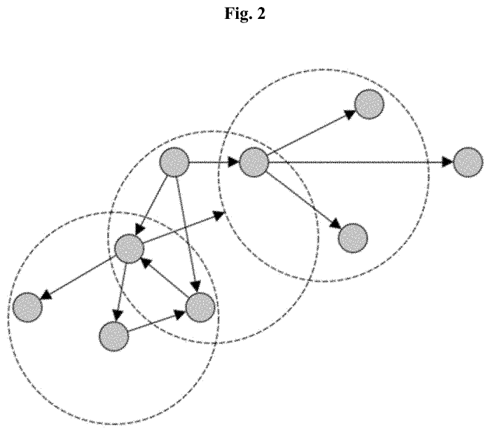

In some embodiments, the first stage in the process is to execute an unsupervised clustering algorithm across the graph. FIG. 2 provides an exemplary conceptualization of the clustering algorithm. A non-limiting example of such an algorithm would be in the kNN class of algorithms, e.g., k-Nearest Neighbor. RTM optionally uses K-Nearest Neighbor for classification problems against the graph. This algorithm works on the principle of assuming that every data point falling near each other is falling in the same class. In other words, it classifies a new data point based on similarity.

This disclosure extends the kNN clustering algorithm into a taxonomical extension. This extension performs a graph-based partition of the underlying data. The methodology described herein, in some embodiments, merges or keeps two clusters apart based on a customized similarity method. Firstly, in some embodiments, objects are clustered in a large number of relatively small sub-clusters. Secondly, in further embodiments, the taxonomy is used to collect instance data. In such embodiments, each data point optionally belongs to multiple collections; this is a point of departure from many algorithms in this space.

The advantage of such embodiments is clear from a conceptual point of view. By way of example, libraries often have to catalog books according to the Dewey Decimal System. Before the advent of more modern search methods, it would be challenging to classify and retrieve, for example, a historical romance with a dominant mystery theme. Embodiments allowing each data point membership in multiple sub-clusters confers an advantage for retrieval without sacrificing precision. In some such embodiments, clusters are repeatedly combined to find the best fit. In further embodiments, the best fit occurs when groups emerge, demonstrating a distance from each point minimized within the collection and maximized outside the set.

In some embodiments, the minimized distance within the cluster is the intercluster connectivity. In some embodiments, the maximized distance between groups is effectively how close those clusters are to each other. Each cluster, in some cases, represents multiple nuanced concepts if the maximized distance is challenging to find.

To define the intercluster connectivity, the subject matter described herein optionally combine the least-squares approach with a notion of the sum of the weight of the edges. In such embodiments, the least-square method helps find the best fitting cluster for a set of data points.

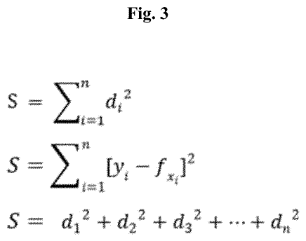

FIG. 3 provides an illustration of the least squares method. In embodiments utilizing the least-squares method, the method connects the vertices throughout the cluster. However, in such embodiments, any weight that exceeds a predetermined threshold (such as the first significant deviation from a computed mean) will cut the vertice and result in the connection occurring outside the cluster. For example, a concept may define five relationships (edges). Four of these relationships may connect the concept to near neighbors, perhaps concepts with a close taxonomical inheritance structure. The fifth relationship may link to a concept far outside the taxonomical network. Thus, in this example, the algorithm disregards this relationship perspective of including the object of that relationship in the current cluster.

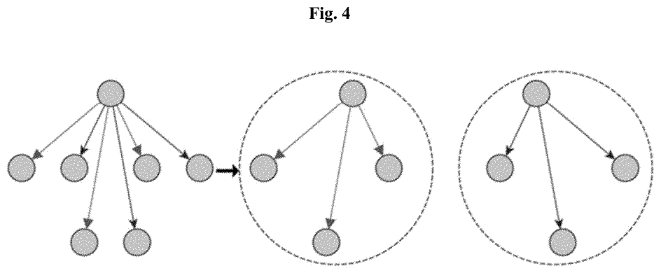

This can be illustrated heuristically, by way of non-limiting example, when considering a node with six relationships. In this example, and as illustrated in FIG. 4, three of these relationships are of one type—perhaps they express a semantic similarity relationship. Also, in this example, three of these relationships are of another kind. They may represent a concept of partonomy or something similar. This single node can become described, in part, in two different clusters. This becomes a question of decomposition.

Although the system optionally enables this clustering method entirely based on semantics, it is helpful, in some embodiments, to use the entire algorithm stated here as the vectorized form of the graph would consider each node in totality. For example, a node may have a similarity relationship that terminates after the first object. After three cycles, a second similarity relationship may exist in a cyclic form and reconnects with the initiating node. Graph vectorization helps quantify these situations on a case-by-case basis and when applying a kNN algorithm forming clusters dynamically rather than heuristically.

In some embodiments, the spatial structure is represent by a weighted graph G. The edge weight from vertex i to j is wij≥0. In such embodiments, the graph is optionally directed (wij not necessarily equal to wji) and may contain self-loops (wii may be positive). In further embodiments, the subject matter described herein requires that the graph is strongly connected, meaning that there is a path of directed edges with nonzero weight from any vertex to any other; for undirected graphs (wij=wji), this reduces to the usual notion connected.

It is impossible to predict what each cluster will contain at this stage. The output of the previous step is mainly dependent on the graph itself. However, the cluster will have a decomposition of the sub-graph that is essentially the same.

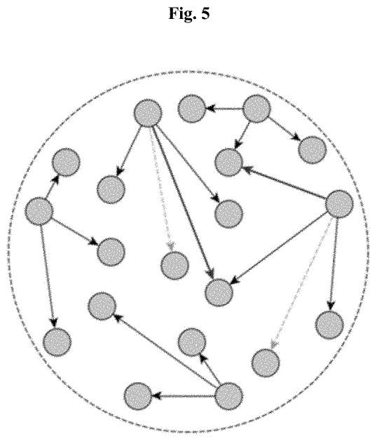

The following exemplary sub-graph, though essentially an over-simplification, represents a cluster with a largely homogenous set of entities. See FIG. 5. Mutation removes two of the relationships (grayed out) and adds two relationships (in purple). In preferred embodiments, concepts are not added or removed from the clusters. Concepts represent anchor points from incoming text to the context within the graph space. Relationships, however, represent the reasons for these concepts and potential inferences. The jitter rate examines the difference in reasoning ability based on the presence or absence of certain relationships. The subject matter described herein, in some embodiments, trigger a uniform random permutation event across each formed cluster. In further embodiments, modifications involve a balance between removing semantic relationships and adding semantic relationships.

In some embodiments, for each permutation of the graph, the system tests both the baseline and modified forms. In further embodiments, the test procedure uses a list of natural language inputs. These inputs are expected to be derived from a formal testing procedure and are reliable tests of the system performance. These inputs, in various embodiments, should manifest a balanced mix of underspecified, fully specified, and overspecified queries. The question list, in preferred embodiments, remains unmodified for the duration of the system.

The subject matter described herein, in some embodiments, produces output and a confidence score each time a question is posed. In preferred embodiments, the test harness asks each question to the same pair of graphs (baseline and modified). The test harness records the output from both the baseline and the modified graph. Both graphs, in some cases, return the same answer but with different confidence levels. The altered graph may have higher or lower confidence. Some relationships may be necessary for filtering solutions out—if missing, this may cause a boost to an answer. The system, in some cases, requires other connections for finding multiple paths to a solution—if missing, this may cause a decrease in confidence. And the adding or removing of relationships may lead to an entirely different answer. A similarity score, in some embodiments, is derived if the output answer deviates from the expected response. The test harness, in some embodiments, quantifies this score as the graph already exists in a vector space form. In either even, deviations in both confidence levels and responses may be quantified and placed in a contingency table.

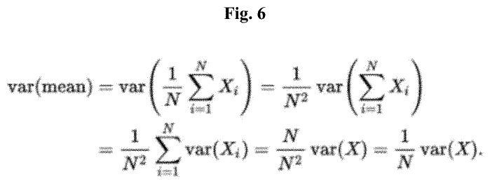

FIG. 6 provides an exemplary contingency computation. A contingency table provides a way of portraying data that can facilitate calculating probabilities. For example, the following python code performs the contingency table computation from the distribution analysis:

```
a = methods.create_np_matrix(self.row_entries)
col_sum = a.sum(axis=0).tolist( )[0]
sorted_col_sum = methods.get_sorted_col_sum(col_sum)
permutation = [ ]
for i in range(0, len(sorted_col_sum)):
  permutation.append(get_i(sorted_col_sum[i]))
a1 = a[:, permutation]
row_sum = [x[0] for x in a.sum(axis=1).tolist( )]
sorted_headers = [ ]
for i in permutation:
  sorted_headers.append(row_entries[0].keys( )[i])
sorted_row_entries = [ ]
for i in range(0, a1.shape[0]):
  row_entry = [row_sum[i]]
  for value in a1[i].tolist( )[0]:
    row_entry.append(value)
  sorted_row_entries.append(row_entry)
def get_i( ):
  for i in range(0, len(sorted_headers)
    if sorted_headers[i] == self.target_flow:
      return i
  return 0
col_1 = [float(x[0]) for x in a1[:, [target_flow_col]].tolist( )]
col_2 = [float(x) for x in row_sum]
variance = 1 − np.mean(np.matrix(col_1) / np.matrix(row_sum))
```

return sorted headers, sorted col sum, sorted row entries, variance

In this non-limiting example, after computing each deviation, each input question and contingency score record has an applied beta distribution. The beta distributions are conjugate with the right-skewed gamma distribution and demonstrate how far each response deviates in a given taxonomical mutation. In this example, as the probability density shifts to the right, the chance of getting a non-similar response increases. A computation of skewness can reduce this density score to a single number.

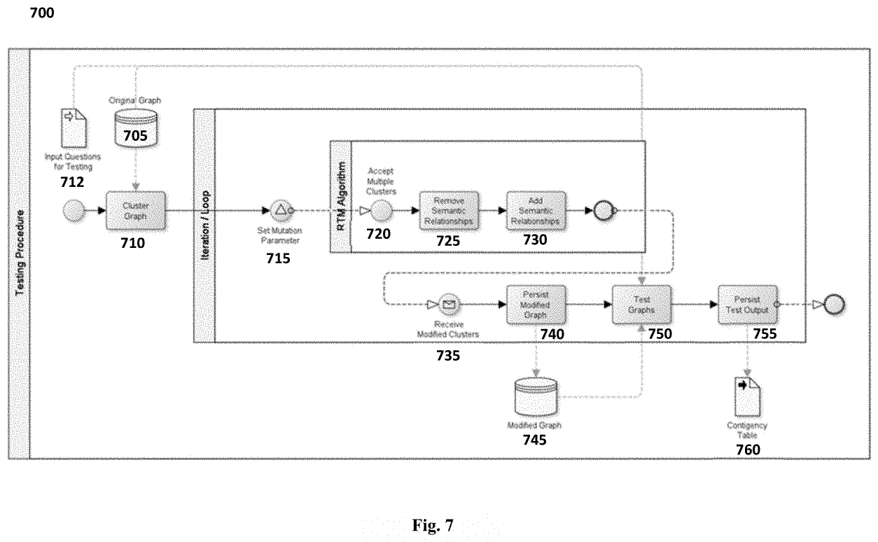

FIG. 7 is an architecture and process diagram illustrating the iterative nature of the subject matter described herein. Referring to FIG. 7, an exemplary configuration 700 includes a testing procedure, including a loop for performing iterations, which further includes the RTM algorithm. The procedure operates on an original graph 705. A clustering algorithm 710 is applied to the original graph 705. Thereafter, the loop iterates by setting a mutation parameter 715, which is used by the RTM algorithm by accepting multiple clusters 720 and then removing 725 and/or adding 730 semantic relationships. Once the RTM algorithm has performed its functions, the loop continues the iteration by receiving the modified clusters 735 and persisting the modified graph 740 to a datastore 745. The loop completes the iteration by applying a test input to test 750 the stored modified graph 745 against the original graph 705 to generate a test output, which is persisted 755 to a contingency table 760 as part of the larger testing procedure.

### EXAMPLES

The following illustrative examples are representative of embodiments of the software applications, systems, and methods described herein and are not meant to be limiting in any way.

### Example 1—Commercial Use Case

The subject matter described herein has a commercial use case for an expert system, or any system that can accept a natural language query and provide a response. The jitter rate is a valuable score for open-ended expert systems, where a user may desire to see explainability. However, expert systems that function in, for example, the technical support space (where a user might ask, “how do I add a new phone to my account?”), explainability is less important. That said, the subject matter described herein is helpful to a team responsible for developing and maintaining such an expert system. For example, if an individual is responsible for a system to answer technical support questions, they want the outcome prediction provided to be very low. A score like this could function as part of the success criteria in such cases. For example, the success criteria could state, “the system is complete when (for a given list of questions) the accuracy exceeds a certain threshold, and the jitter does not rise above a certain threshold.”

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented system for assessing the resiliency of reasoning of an expert system comprising a natural language interface and a graph database, the system comprising at least one computing device comprising at least one processor and instructions executable by the at least one processor to perform assessment operations comprising:
a) recording a baseline graph of the expert system;
b) submitting a test input to the expert system, the expert system utilizing the baseline graph, the test input comprising a plurality of queries;
c) recording baseline responses of the expert system to the test input;
d) applying an algorithm to iteratively perform randomized mutation of the graph, constrained according to a mutation parameter, by performing mutation operations comprising:
i) executing an unsupervised clustering algorithm across the graph,
ii) modifying each cluster,
iii) reassembling the modified clusters into a modified graph,
iv) persisting the modified graph of the expert system,
v) submitting the test input to the expert system, the expert system utilizing the modified graph, and
vi) recording new responses of the expert system to the test input; and
e) generating a predictive output comprising a measure of potential future mutability of outcome when the expert system ingests new data or a measure of potential deviation from an expected reasoning pattern when the expert system ingests new data.

2. The system of claim 1, wherein the test input comprises underspecified queries, fully specified, and overspecified queries.

3. The system of claim 1, wherein the clustering algorithm comprises a k-Nearest Neighbor (kNN) algorithm.

4. The system of claim 1, wherein the assessment operations further comprise setting the mutation parameter.

5. The system of claim 1, wherein modifying the clusters comprises modifying one or more edges of the graph.

6. The system of claim 5, wherein modifying one or more edges of the graph comprises: adding at least one semantic relationship to the graph, subtracting at least one semantic relationship from the graph, or both.

7. The system of claim 6, wherein modifying the clusters comprises adding at least one semantic relationship to the graph.

8. The system of claim 6, wherein modifying the clusters comprises subtracting at least one semantic relationship from the graph.

9. The system of claim 5, wherein the mutation parameter constrains the randomized mutation to modifying about 1%, about 2%, about 3%, about 4%, about 5%, about 6%, about 7%, about 8%, about 9%, or about 10% of the edges of the graph.

10. The system of claim 5, wherein the mutation parameter constrains the randomized mutation to modifying less than 1%, less than 2%, less than 3%, less than 4%, less than 5%, less than 6%, less than 7%, less than 8%, less than 9%, or less than 10% of the edges of the graph.

11. The system of claim 5, wherein the mutation parameter constrains the randomized mutation modifying about than 1% to about 5% of the edges of the graph.

12. The system of claim 5, wherein the mutation parameter constrains the randomized mutation to modifying about than 5% to about 10% of the edges of the graph.

13. The system of claim 1, wherein the mutation does not comprise modifying a node of the graph.

14. The system of claim 1, wherein the assessment operations further comprise updating the mutation parameter in response to the new responses of the expert system to the test input.

15. The system of claim 1, wherein the baseline responses and the new responses of the expert system comprise an answer to each query and a confidence level for the answer to each query.

16. The system of claim 1, wherein the assessment operations further comprise quantifying deviations in both confidence levels and responses between the baseline responses and the new responses.

17. The system of claim 1, wherein the predictive output comprises a measure of how resilient to further assertions the reasoning of the expert system is with respect to a query.

18. The system of claim 1, wherein the predictive output is provided to the expert system or a user of the expert system.

19. The system of claim 1, wherein the predictive output is provided as a measure of jitter.

20. A computer-implemented system comprising:
a) an expert system comprising a natural language interface and a graph database; and
b) at least one computing device comprising at least one processor and instructions executable by the at least one processor to perform operations for assessing the resiliency of reasoning of the expert system, the operations comprising:
i) recording a baseline graph of the expert system;
ii) submitting a test input to the expert system, the expert system utilizing the baseline graph, the test input comprising a plurality of queries;
iii) recording baseline responses of the expert system to the test input;
iv) applying an algorithm to iteratively perform randomized mutation of the graph, constrained according to a mutation parameter, by performing mutation operations comprising:
1) executing an unsupervised clustering algorithm across the graph,
2) modifying each cluster,
3) reassembling the modified clusters into a modified graph,
4) persisting the modified graph of the expert system,
5) submitting the test input to the expert system, the expert system utilizing the modified graph, and
6) recording new responses of the expert system to the test input;
v) generating a predictive output comprising a measure of potential future mutability of outcome when the expert system ingests new data or a measure of potential deviation from an expected reasoning pattern when the expert system ingests new data; and
vi) providing the predictive output to the expert system or a user of the expert system.

21. A computer-implemented method of assessing the resiliency of reasoning of an expert system comprising a natural language interface and a graph database, the method comprising:
a) recording a baseline graph of the expert system;
b) submitting a test input to the expert system, the expert system utilizing the baseline graph, the test input comprising a plurality of queries;
c) recording baseline responses of the expert system to the test input;
d) applying an algorithm to iteratively perform randomized mutation of the graph, constrained according to a mutation parameter, by performing mutation operations comprising:
i) executing an unsupervised clustering algorithm across the graph,
ii) modifying each cluster,
iii) reassembling the modified clusters into a modified graph,
iv) persisting the modified graph of the expert system,
v) submitting the test input to the expert system, the expert system utilizing the modified graph, and
vi) recording new responses of the expert system to the test input; and
e) generating a predictive output comprising a measure of potential future mutability of outcome when the expert system ingests new data or a measure of potential deviation from an expected reasoning pattern when the expert system ingests new data.
